(19) United States
(12) Patent Application Publication
(10) Pub. No.: US 2002/0124458 A1
(43) Pub. Date: Sep. 12, 2002

(54) In-ground pest bait station

(76) Inventor: Terry J. Clark, Lodi, CA (US)

Correspondence Address: PATENT DEPARTMENT, ATTN: PETER R. LEAL, ESQ., GRAY CARY WARE & FREIDENRICH LLP, 1755 EMBARCADERO ROAD, PALO ALTO,, CA, 94303-3340, US

(21) Appl. No.: 09/801,228

(22) Filed: Mar. 7, 2001

(51) Int. Cl. A01M 1/00

(52) U.S. Cl. 43/124

(57) ABSTRACT

An in-ground bait station for pest detection and control includes a first housing tube fixedly implanted into the ground and a removable reservoir within the housing. The reservoir contains pesticide for detecting and controlling pest activity, and can be inspected or replaced by removing the reservoir from the housing. The bait station further includes a cap to provide evaporation control and tampering resistance when the reservoir and housing are installed below ground and to provide an additional receptacle containing bait for detecting and controlling pest activity. The cap includes a detachable bait tray. The bait tray contains a receptacle between an inner and outer edge for holding bait. The bait tray is designed to cooperate with the housing to oppose rotational movement of the cap when the bait station is in an operational state. The cap is designed to cooperate with the bait tray to provide evaporation control and tampering resistance when the housing and bait tray are installed in the ground.

### 1. FIELD OF THE INVENTION

The present invention relates generally to bait stations, and more particularly to in-ground pest bait stations containing liquid and non-liquid bait and sticky monitor cards.

### 2. BACKGROUND OF THE INVENTION

Various devices have been developed to help control insect pest populations. Some of these devices trap pests within the device, either by mechanical barriers or by sticky surfaces. Other devices contain poison bait, in either liquid or non-liquid form.

For example, U.S. Pat. No. 5,966,863 to Payton et al. discloses a multi-compartment liquid bait station for control of ants. Another liquid bait station is disclosed in U.S. Pat. No. 5,943,816 to Hyatt et al., which describes a liquid bait station with capillary feeding pores. Similarly, U.S. Pat. No. 5,875,586 to Ballard et al., refers to dispensing liquid bait in a refillable manner, including a transparent bait station into which liquid bait may be injected. U.S. Pat. No. 5,802,761 to Demarest et al., reveals a multiple-chamber non-liquid bait station. These bait stations are placed above the ground.

An in-ground bait device for the control of termites is described in U.S. Pat. No. 5,901,496 to Woodruff. The device is a termite-destroying bait tube that has a first housing tube fixedly implanted into the ground and a second inner tube removably receivable within the housing. The inner tube can be removed from the outer tube, thus allowing for inspection and replacement.

Developers of pest bait stations are faced with a number of challenges. First, because some baits may be dangerous to people and pets, it is important that the bait be relatively inaccessible to children and pets, but fully accessible to the targeted pests. Second, although liquid bait can be more effective, it is also subject to evaporation, thereby necessitating inconvenient monitoring and refilling of the liquid. Third, different baits and bait station configurations may be appropriate for different pests, thus often necessitating multiple bait stations.

Thus, there is a continuing need for a bait station that is relatively inaccessible to children and pets but fully accessible to pests, that limits the evaporation of liquid bait, and that can be used against a variety of pests.

### 3. SUMMARY OF THE INVENTION

Accordingly, it is an advantage of the present invention that it is placed in the ground, and is therefore relatively inaccessible to children and pets.

It is a further advantage of the present invention that it controls evaporation of liquid bait by placing such bait substantially in the ground, moderating the temperature and therefore the evaporation rate of the liquid bait.

It is a further advantage of the present invention that it controls evaporation of liquid bait by placing such bait in a substantially enclosed environment, with a removable cap for easy access to inner portions of the bait station.

It is a further advantage of the present invention that its entry ports can be adjusted in size so as to accommodate pests of different sizes.

It is a further advantage of the present invention that it can simultaneously accommodate liquid bait, solid bait, and an area for insertion of a sticky monitor card for the capture of pests. A sticky monitor card is a card with an adhesive surface designed to capture insects and other pests by trapping them on its adhesive surface.

The present invention provides an in-ground device and system for controlling pests. It is generally comprised of a housing, a reservoir, a bait tray, a cap and, optionally, a reservoir access.

The housing is of a generally tubular shape and includes a peripheral flange on its upper portion. The flange includes a peripheral wall extending upwardly from the outer edge of the flange. The peripheral wall defines at least one opening for the entry of pests. The housing defines an inner cavity, for the placement of the reservoir. The tubular shape need not be uniform in cross-section along its length, and non circular cross sections may be used, e.g., ellipsoid, triangular, rectangle, hexagonal, octagonal, etc. Preferably, the tubular shape, peripheral flange and wall are circular.

The housing lower portion may contain one or more protuberances extending outwardly from the housing to help prevent the housing from dislodging once it is implanted in the ground. In use, most of the housing is implanted in the ground, with the peripheral flange approximately at ground level. Of course, the flange may extend above or be recessed below ground level during use.

The reservoir rests within the inner cavity of the housing, and is generally of a tubular shape, preferably tapered from top to bottom. In use, the reservoir contains the liquid bait.

The reservoir access, when employed, is an elongated plastic tab or other bridging device. In use, the reservoir access helps facilitate pests' access to the liquid bait.

The bait tray is of a shape designed to removably attach to the top of the housing and beneath the cap. It includes at least one receptacle formed by a peripheral wall extending upwardly, a peripheral inner wall also extending upwardly, and a solid base at the bottom. The base may be coated with sticky coatings for trapping pests. The bait tray may also have one or more transverse walls connecting the peripheral wall and the inner wall. Such transverse walls define separate receptacles within the bait tray. At least one raised element extends upwardly from the peripheral portion of the bait tray.

The peripheral wall of the bait tray includes at least one opening for the entry of insect pests. It also may include adjustable portions so that the size of the openings may be adjusted to allow for entry of larger or smaller pests, as desired.

When mounted to the bait station, the lower surface of the bait tray defines at least one recess in radial alignment with at least one protruding element extending upwardly from the flange of the housing. The recess is designed and arranged to cooperate with the protruding element so that rotation of the cover relative to the housing is permitted only in a predetermined direction and is opposed in the opposite direction.

The cap is adapted to removably attach on top of the bait tray to prevent access to the bait and to help control evaporation of liquid bait. The cap is generally solid, but may define a means for ventilation such as a means therethrough. It includes a downwardly extending peripheral wall which connects, either snap fit, thread fit or both, to the bait tray.

In a further aspect of the present invention, supporting elements, preferably stop bosses, extend upwardly from the flange portion of the housing. The stop bosses and the flange are arranged to cooperate with each other for supporting the bait tray so that excessive strain is removed from the region at which the bait tray engages the housing. In this manner, deflection or displacement of the bait tray relative to the housing is reduced to assure that the opening remains in substantial alignment in the operational state of the bait station.

### 4. BRIEF DESCRIPTION OF THE DRAWINGS

These and other features, aspects and advantages of the present invention will become better understood with reference to the following detailed description, made with reference to the accompanying drawings, in which like reference numbers refer to like elements, and in which:

FIG. 1 is a side view of a preferred embodiment of an in ground pest control bait station of the subject invention;

FIG. 2 is a top plan view of the pest control bait station of FIG. 1;

FIG. 3 is a side view of the cap of the pest control bait station of FIG. 1;

FIG. 4 is a side view of the bait tray of the pest control bait station of FIG. 1;

FIG. 5 is a side view of the assembled cap and bait tray of the pest control bait station of FIG. 1;

FIG. 6 is an elevated perspective view of the bait station of FIG. 1;

FIG. 7 is an elevational view, partly in section, of a receptacle of the pest control bait station of FIG. 1;

FIG. 8 is a top plan view of the receptacle illustrated by FIG. 7 received within the housing of the pest control bait station of FIG. 1;

FIG. 9 is a drawing of the tab portion of the receptacle portion of the pest control bait station of FIG. 1; and

FIG. 10 is a side elevational view, in section, of the pest control bait station of FIG. 1 illustrating the operative relationship between the receptacle and housings of the bait station and the assembled cap mounted over the assembled bait station.

### 5. DETAILED DESCRIPTION OF THE PREFERRED EMBODIMENT.

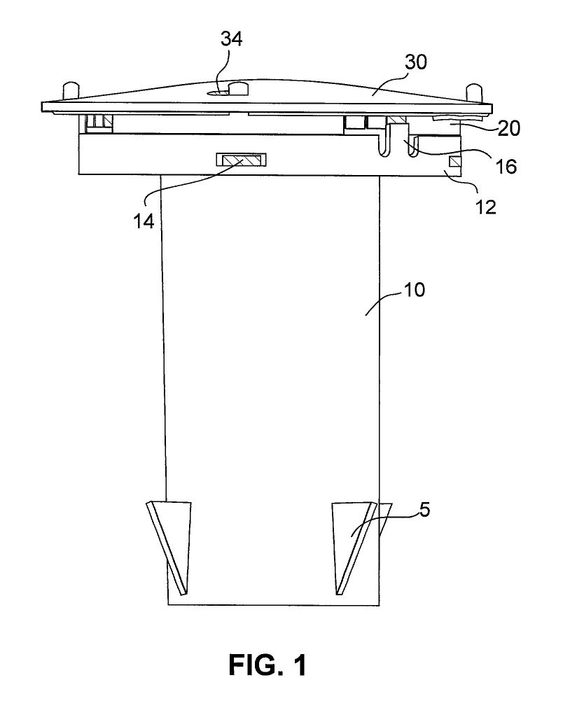

A preferred embodiment of a bait station in accordance with the present invention will now be discussed with reference to FIGS. 1-10.

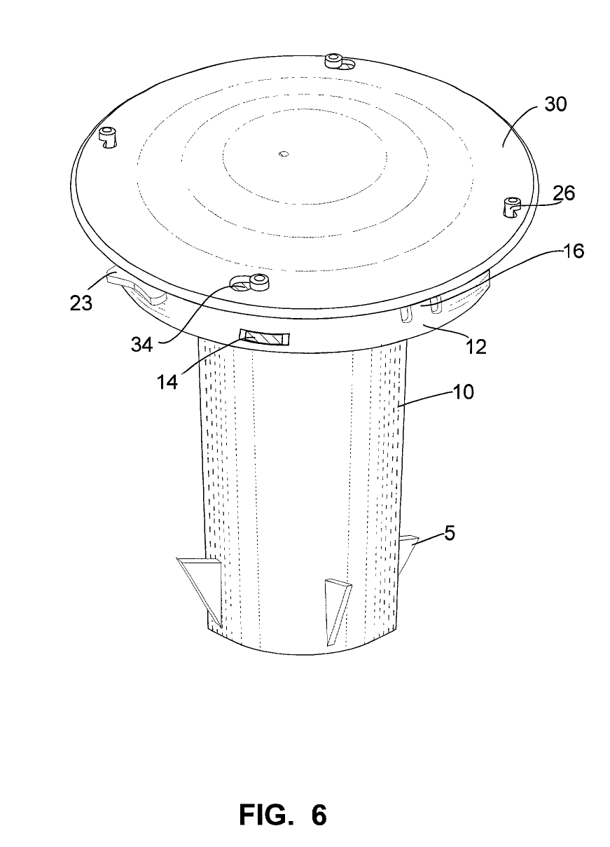

Referring first to FIGS. 1 and 6, a housing is designated by the reference numeral 10, a bait tray is designated by the reference numeral 20, and a cap is designated by the numeral 30. In this embodiment, housing 10 has a circular cross section.

Referring to the bait station illustrated by FIGS. 1-6, housing 10 is fixedly implanted in the ground. A plurality of outwardly extending elements 5, including, but not limited to, generally wedge shaped fins or protuberances, semi-circular shaped protuberances, rectangular shaped protuberances or square shaped protuberances, are mounted to the outer surface of housing 10. Preferably the elements 5 extend outwardly in a radial orientation and are arranged along the outer surface of housing 10. Elements 5 are provided to prevent dislodgment and rotation of housing 10 once it is implanted into the ground, and in particular, to minimize movement of housing 10 when removing cap 30 and bait tray 20.

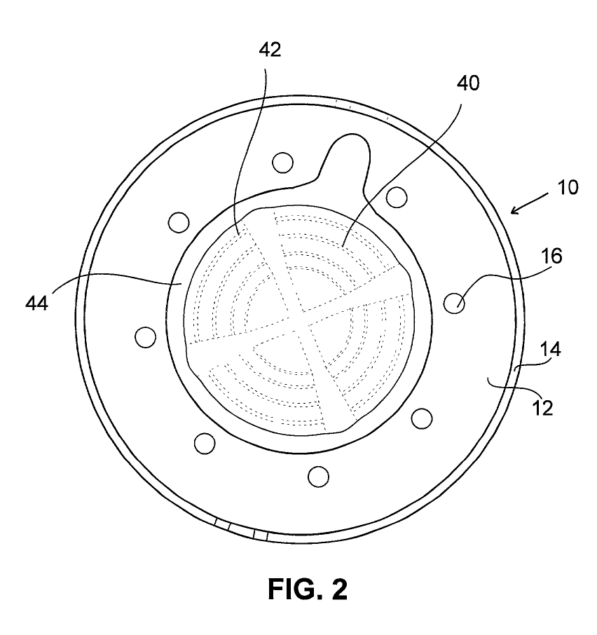

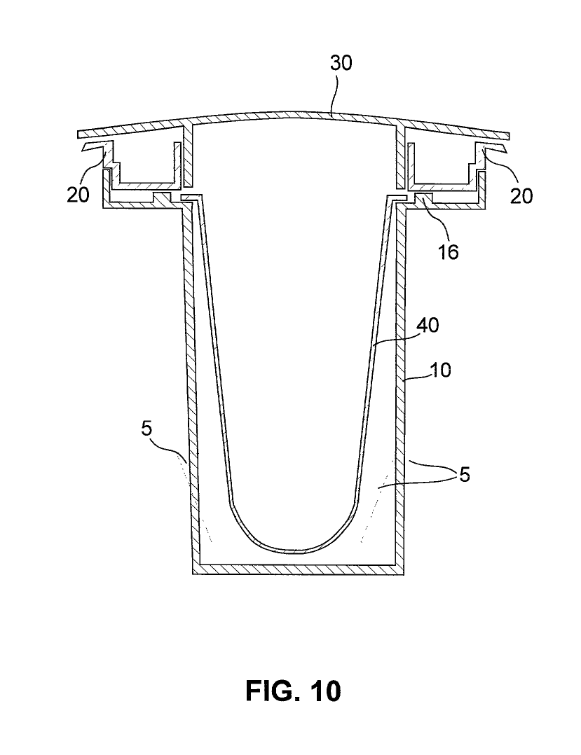

FIG. 2 illustrates housing 10 and a reservoir designated by reference numeral 40. Reservoir 40 is movable relative to housing 10. As illustrated in FIG. 10, reservoir 40 is removably received within housing 10. Reservoir 40 is configured to receive a liquid bait therein. The upper portion of housing 10 comprises a flange designated by reference numeral 12. At the outer edge flange 12 there is an upwardly extending edge or wall designated by reference numeral 14. A plurality of stop bosses 16 are mounted to the top of flange 12 of housing 10 to support bait tray 20 when it is attached.

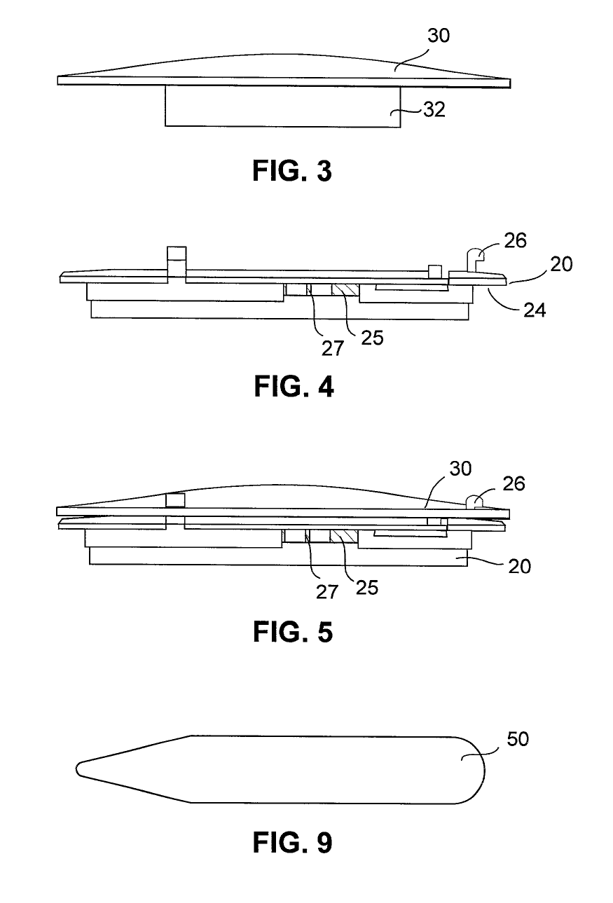

FIG. 3 illustrates cap 30. Preferably, the radius of cap 30 should be greater than the radius of housing 10. The inner portion of cap 30 consists of a downwardly extending peripheral edge 32 designed to engage in the center portion of bait tray 20. As illustrated in FIGS. 1 and 6, cap 30 defines a plurality of openings 34 which are designed to cooperate with a raised element 26 extending upwardly from bait tray 20.

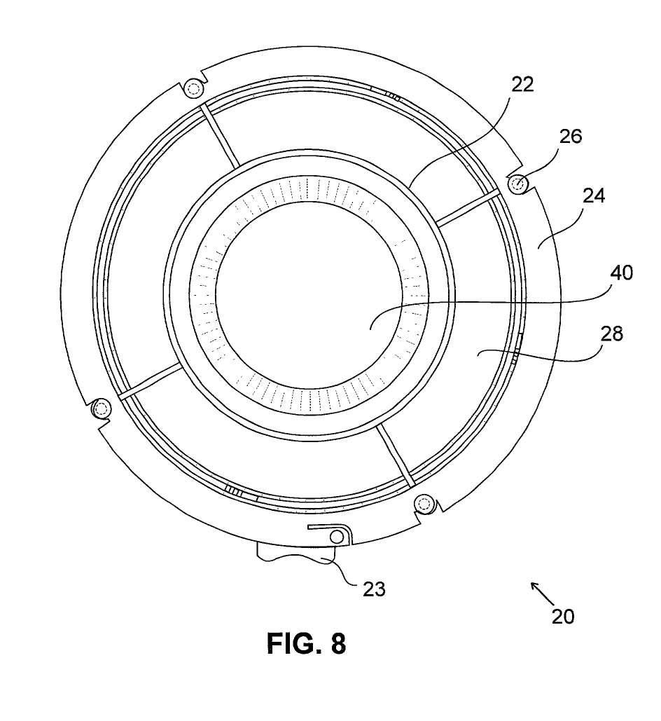

FIGS. 4-8 and 10 illustrate bait tray 20, which preferably is generally circular shaped defining an opening in the center designated by reference numeral 22. Bait tray 20 has an outward edge which has an outwardly extending rim portion 24. Rim portion 24 includes a plurality of raised elements designated by reference numeral 26 which are designed to cooperate with openings 34 of cap 30. The inner edge of bait tray 20 opening 22 and outwardly extending rim 24 provide the exterior portions of a receptacle portion of the bait tray designated by reference numeral 28 (see FIG. 8). In its assembled operational state, receptacle 28 is designed to contain a sticky monitor card which will detain pests which enter the bait tray 20. The pests enter bait tray 20 through openings 25 (FIGS. 4, 5), which are defined by the outer edge bait tray 20.

The outer edge of the bait tray 20 also defines smaller openings designated by reference numeral 27 which are designed so that the portion of material between openings 25 and 27 may be broken away to permit larger pests to enter the bait tray 20.

FIG. 5 illustrates cap 30 mounted to bait tray 20. As illustrated most clearly by FIG. 6 upwardly extending elements 26 of bait tray 20 engage the openings defined in cap 34 for securing cap 30 to the bait tray 20. In the operational state as indicated by FIG. 5, when assembled the central portion of cap 30 closes the opened portion of receptacle 28 in bait tray 20 and the peripheral portion of cap 30 covers outwardly extending rim portion 24 of bait tray 20.

FIG. 6 illustrates cap 30 together with bait tray 20 in an assembled state mounted to the top of housing 10. As illustrated in FIGS. 1 and 6, flange 12 of housing 10 defines openings 14 which allow pests to enter housing 10 of the bait station. The peripheral edge of flange 12 defines a plurality of clips designated by reference numeral 16. Clips 16 are designed to cooperate with openings 25 defined by cap 30.

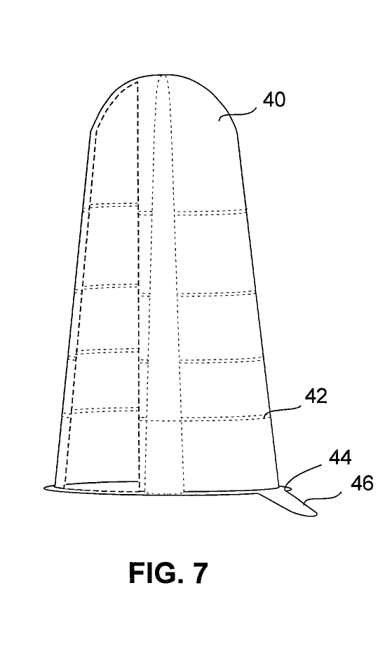

FIG. 7 illustrates a reservoir designated by reference numeral 40. Reservoir 40 contains a plurality of measurement notches 42 which permits the appropriate quantity of bait to be placed in the bait station. Reservoir 40 has an upper portion which includes a flange 44 such that when it is placed within housing 10, flange 44 rests upon flange 12 of the housing so that reservoir 40 is removably receivable within housing 10, as illustrated in FIG. 8.

FIG. 9 illustrates the reservoir access of the bait station, which allows the pests to travel from the top portion of the bait station into reservoir 40 containing bait.

In its assembled, operational state, the cover 30 is just above ground level. When the bait station is to be disassembled and reservoir 40 is to be removed from housing 10, the tab portion designated by reference numeral 23 illustrated in FIG. 8 is depressed downwardly, causing the upwardly extending elements 26 to disengage from openings 34 defined in cap 30. By raising the cap portion access is provided to clips 16 on inner housing 10. In its preferred state, the tab portion 23 of the reservoir is in a vertical position such that said reservoir 40 can be removed without removing the bait tray. By releasing clip 16, access is gained to housing 10 such that reservoir 40 can be removed.

In operation of the bait station illustrated by FIGS. 1-10, housing 10 is driven in ground at a pre-selected location. Housing 10 is typically set in a pre-cut hole to a depth such that the radially extending flange 12 is substantially at ground level. The receptacle 28 may be either pre-loaded with bait or loaded with bait after it is received within the implanted housing after housing 10 is implanted inground.

After housing 10 and receptacle 28 have been implanted in the ground, bait tray 20 is placed over flange 12 of the housing. Non-liquid bait may then be added in receptacle 28 of bait tray 20. Cap 30 is then snapped on to bait tray 20.

Preferably, the bait station is implanted so that the portion of housing 10 below flange 12 is in the ground. Flange 12 of housing 10 is desirably located at or near ground level so that the pests can easily crawl or slither in through the openings defined by or in housing 10. After entering, the pests can then traverse flange 12 portion of housing 10 to reservoir 40 to ingest the liquid bait. Additional access to the liquid pesticide may be provided by a reservoir access, such as a tab, which can be used as a ramp into the liquid bait.

Another advantage of the present invention is that is can be presented as a pest control kit comprising the element of a in-ground pest control bait station having a reservoir for holding a liquid bait, and a receptacle for holding a solid bait; a liquid bait; a non-liquid bait; and a sticky monitor card.

Advantages of having a bait station which is located in ground include evaporation minimization and tamper resistance. When fully assembled, the bait tray and cap attached to the housing further minimize evaporation and tampering. Furthermore, because much of the station is below ground, the temperature within the bait station is moderated so that evaporation is controlled.

The bait tray contains a receptacle or receptacles which may contain sticky monitor cards to trap pests, and which may also contain non-liquid bait for additional pest control. Pests access the bait tray through an opening defined by the upwardly extending outer wall of the bait tray. Once the pests enter the bait tray they may be subjected to the sticky monitor card of the flange portion of the bait tray.

The device can be used with a wide variety of non-liquid, liquid baits, and gel baits including a pesticidal agent. Of course, users will employ different types of bait depending on the targeted pest or pests and other circumstances. The bait can be loaded in the pest station either before or after the station is implanted in the ground. The present invention is believed to be effective against a great variety of “door-yard” pests, including ants and earwigs, as well as snails and slugs, pill bugs, sow bugs, beetles, cockroaches, centipedes and millipedes, etc.

The pest bait station of the present invention can be made of any number of materials. In the preferred embodiment, the device is made of molded plastic, using conventional techniques.

One skilled in the art will appreciate that the present invention can be practiced by other than the preferred embodiments, which are presented for purposes of illustration and not of limitation. In addition, the specific structures identified herein are useful or representative structures, and it should be understood that different structures may be used without departing from the spirit and scope of the invention.

1. An in-ground pest control bait station comprising:
a housing implantable in the ground, said housing having a reservoir to receive a liquid bait and said housing defining an opening for the entry of pests;
a bait tray removably attached to a housing top, said bait tray having a top and defining a receptacle for holding a first non-liquid bait; and
a cap removably attached to said bait tray top.

2. The bait station according to claim 1, wherein said reservoir is removable from said housing.

3. The bait station according to claim 1, further comprising means for allowing pest access to said liquid bait.

4. The bait station according to claim 1, further comprising an opening in said bait tray for entry of pests.

5. The bait station according to claim 1, said cap further comprising a means for ventilation for said liquid bait.

6. The bait station according to claim 1, further comprising a liquid bait in said reservoir comprising boric acid.

7. The bait station according to claim 1, wherein said receptacle contains a first non-liquid bait.

8. The bait station according to claim 1, wherein said receptacle is designed to accept a sticky monitor card.

9. The bait station according to claim 1, wherein said housing further comprises at least one outwardly extending element for securing said housing in ground.

10. The bait station according to claim 1, wherein said securing means further comprises at least one wedge-shaped protuberance.

11. An in-ground pest control bait station, comprising:
a housing implantable in the ground, said housing having a top and defining at least one opening for entry of pests;
a reservoir disposed within said housing for holding a liquid bait;
a bait tray removably attached to said housing top, said bait tray having a top and containing a receptacle for holding a bait and defining at least one opening for entry of pests; and
a cap removably attached to said bait tray.

12. The bait station according to claim 11, further comprising means for allowing access to said liquid bait.

13. The bait station according to claim 11, further comprising a liquid bait including an insecticidal agent in said reservoir.

14. The bait station according to claim 11, wherein said reservoir is removable from said housing.

15. The bait station according to claim 11, wherein said receptacle is designed to accept a sticky monitor card.

16. A pest control bait station comprising:
a housing for implanting in the ground;
a reservoir removably receivable within said housing for holding liquid bait and said housing defines at least one opening for entry of pests;
a bait tray removably attached on top of said housing, said bait tray containing receptacle for holding insect bait; and
a cap removably attached on top of said bait tray, said cap containing a means for ventilation.

17. The bait station according to claim 16, further comprising means for allowing access to said liquid bait.

18. The bait station according to claim 16, wherein said bait tray defines at least one opening for entry of pests.

19. The bait station according to claim 16, wherein said receptacle is designed to accept a sticky monitor card.

20. The bait station according to claim 16, wherein said housing contains at least one outwardly extending element for securing said housing in ground.

21. An in-ground pest control bait station comprising:
a reservoir for holding liquid bait, and
a receptacle for holding non-liquid bait.

22. The bait station according to claim 21, wherein said reservoir is above ground level.

23. The bait station according to claim 21, wherein said reservoir is below ground level.

24. An in-ground pest control bait station comprising:
a reservoir for holding liquid bait,
a receptacle for holding non-liquid bait, and
a sticky monitor card for trapping pests.

25. The bait station according to claim 24, wherein said reservoir is above ground level.

26. The bait station according to claim 24, wherein said reservoir is below ground level.

27. A method for pest control comprising:
loading a bait station with liquid bait; and
implanting said station in the ground so that said liquid bait is below ground level.

28. A method for pest control comprising:
loading a bait station with liquid bait;
loading a bait station with non-liquid bait; and
implanting said station in the ground.

29. The method according to claim 28, wherein said bait station is implanted in the ground so that said liquid bait is below ground level.

30. A pest control kit comprising:
an in-ground pest control bait station having a reservoir for holding a liquid bait, and a receptacle for holding a solid bait;
a liquid bait;
a non-liquid bait; and
a sticky monitor card.

31. The kit according to claim 30 wherein the liquid bait comprises an insecticidal agent.
